(19) United States
(12) Patent Application Publication
(10) Pub. No.: US 2018/0323452 A1
(43) Pub. Date: Nov. 8, 2018

(54) MODELING AND USE OF VIRTUAL TEMPERATURE SENSOR AT FUEL CELL STACK ACTIVE AREA OUTLET WITH STACK COOLANT BYPASS

(71) Applicant: GM GLOBAL TECHNOLOGY OPERATIONS LLC, DETROIT, MI (US)

(72) Inventors: DANIEL W. SMITH, SHELBY TOWNSHIP, MI (US); JUN CAI, PONTIAC, MI (US); ANDREW J. MASLYN, FARMINGTON, MI (US)

(21) Appl. No.: 15/587,700

(22) Filed: May 5, 2017

(51) Int. Cl. H01M 8/0432; H01M 8/04007

(52) U.S. Cl. CPC H01M 8/04358; H01M 8/04067

(57) ABSTRACT

A fuel cell temperature-measuring system includes a coolant source that provides coolant at a total coolant flow rate and an initial coolant temperature. A flow field plate defines peripheral flow channels and active area flow channels through which coolant flows. The flow field plate is adapted to be positioned in a fuel cell stack between individual fuel cells. A total coolant flow provided to the common input divides into a bypass flow that flows through the peripheral flow channels and an active area flow that flows through the active area flow channels. The bypass flow combines with the active area flow to emerge from the common output with an output coolant temperature. The fuel cell temperature-measuring system includes a temperature sensor that measures the output coolant temperature from the common output. Finally, a temperature estimator estimates an active area coolant temperature from the output coolant temperature.

### TECHNICAL FIELD

In at least one aspect, the present invention is related to methods and systems for determining and controlling fuel cell stack temperatures, and in particular, the temperature of coolant near the fuel cell active area which cannot be directly measured.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”), to provide ion transport between the anode and cathode.

In proton exchange membrane type fuel cells, hydrogen is supplied to the anode as fuel, and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane (i.e., ion conducting membrane) has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles) supported on carbon particles to promote oxidation of hydrogen at the anode, and reduction of oxygen at the cathode. Protons flow from the anode through the ionically conductive polymer membrane to the cathode where they combine with oxygen to form water, which is discharged from the cell. The MEA is sandwiched between a pair of porous gas diffusion layers (“GDL”) which in turn are sandwiched between a pair of non-porous, electrically conductive flow field plates. The plates function as current collectors for the anode and the cathode, and contain appropriate channels and openings formed therein for distributing a liquid coolant and the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

In some flow field designs, there is a liquid coolant by pass flow that is used to cool the fuel cell at the periphery were seal between plates are made. In these design, coolant temperature control is complicated by the differing temperatures between the coolant flowing through peripheral channels in the flow field and internal channels that are near the fuel cell active areas. In some early designs, there is no coolant bypass flow, therefore it is relatively straightforward for stack temperature control.

Accordingly, there is a need for improved methods and systems for controlling fuel cell stack temperatures.

### SUMMARY

The present invention solves one or more problems of the prior art by providing in at least one embodiment, a fuel cell temperature-measuring system is provided. The fuel cell measuring system includes a coolant source that provides coolant at a total coolant flow rate and an initial coolant temperature. A flow field plate defines coolant flow channels through which the coolant flows. The coolant flow channels including peripheral flow channels and active area flow channels. The peripheral flow channels and the active area flow channels diverge from a common input and converge to a common output. The flow field plate is adapted to be positioned in a fuel cell stack between individual fuel cells. An input coolant liquid with a total coolant flow rate provided to the common input divides into a bypass flow that flows through the peripheral flow channels with a bypass coolant flow rate and a bypass coolant temperature and an active area flow that flows through the active area flow channels with an active area flow rate and an active area temperature. The bypass flow combines with the active area flow to emerge from the common output as an output coolant with an output coolant temperature. The fuel cell temperature-measuring system includes a temperature sensor that measures the output coolant temperature from the common output. Finally, a temperature estimator estimates an active area coolant temperature from the output coolant temperature.

### BRIEF DESCRIPTION OF THE DRAWINGS

FIG. 1 is a schematic cross section of a fuel cell stack that can incorporate a temperature measuring system;

FIG. 2 is a schematic cross section of a fuel cell used in the fuel cell stack of FIG. 1;

FIG. 3 provides a CFD plot of the stack active area temperature using energy balance model;

FIG. 4 is a schematic cross section of a fuel cell temperature-measuring system

FIG. 5 is a flow chart illustrating a method for controlling the fuel cell stack active area temperature;

FIG. 6 provides temperature control simulation data based on active area temperature; and

FIG. 7 provides a flowchart showing the implementation of a pressure estimation method.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. It, where i is an integer) include alkyl, lower alkyl, C₁₋₆ alkyl, C₆₋₁₀ aryl, or C₆₋₁₀ heteroaryl; single letters (e.g., “n” or “o”) are 1, 2, 3, 4, or 5; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

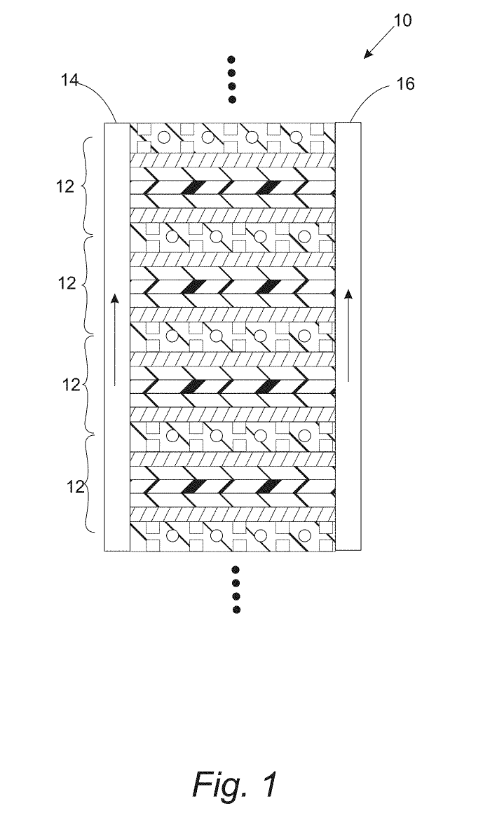

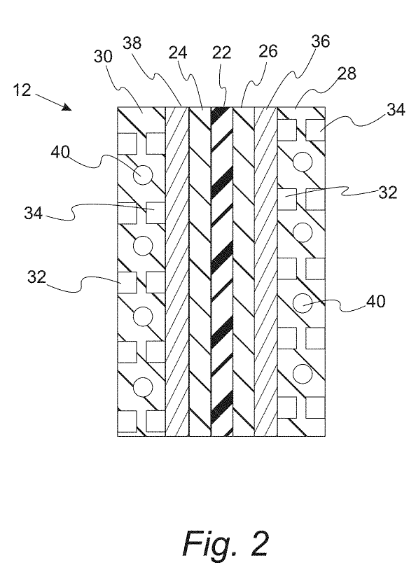

With reference to FIGS. 1 and 2, schematics of a fuel cell and fuel cell stack incorporating a temperature measuring system are provided. FIG. 1 is a schematic cross section of a fuel cell stack that can incorporate a temperature measuring system. FIG. 2 is a schematic cross section of a fuel cell used in the fuel cell stack of FIG. 1. Fuel cell stack 10 includes a plurality of proton exchange membrane (PEM) fuel cells 12. Typically, a fuel cell stack may include 10 to 30 or more individual fuel cells. Fuel gases (e.g., hydrogen gas), oxygen-containing gas (e.g., air, O₂, etc.), and coolant (e.g., water) are provided at header sections 14 and 16. Fuel cell 12 includes polymeric ion conducting membrane 22 disposed between cathode catalyst layer 24 and anode catalyst layer 26. Fuel cell 12 also includes flow fields 28, 30, gas channels 32 and 34, and gas diffusion layers 36 and 38. In a refinement, flow fields 28, 30 are bipolar plates each having an anode side and a cathode side. In particular, flow fields 28, 30 are formed by combining an anode flow field plate and a cathode flow field plate. Coolant is supplied through cooling channels 40. During operation of the fuel cell, a fuel such as hydrogen is fed to the flow field plate 28 on the anode side and an oxidant such as oxygen is fed to flow field plate 30 on the cathode side. Hydrogen ions generated by anode catalyst layer 26 migrate through polymeric ion conducting membrane 22 where they react at cathode catalyst layer 24 to form water. This electrochemical process generates an electric current through a load connect to flow field plates 28 and 30.

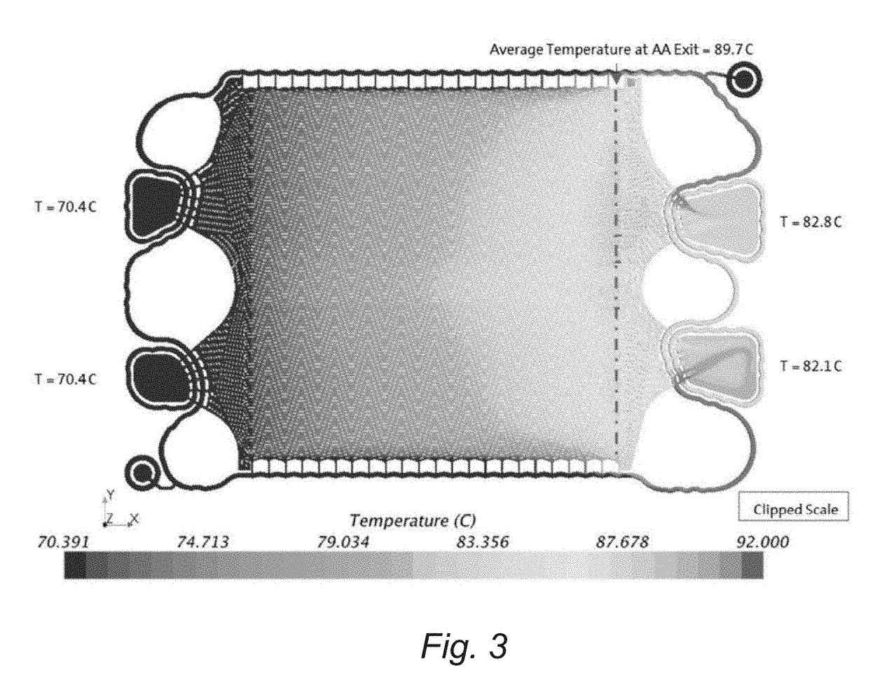

With reference to FIG. 3, a computational fluid dynamics (CFD) plot of the stack active area temperature using energy balance model is provided. FIG. 3 indicates that active area temperature of the fuel cells is 5-6° C. higher than the downstream coolant outlet temperature. The temperature measuring system set forth below directly address the potential deleterious effects of this temperature elevation. The current flow field designs having a metal bead seal around 15% to 30% coolant bypass flow on the plate and this bypass results in the active area outlet temperature exceeding the downstream coolant outlet temperature at T167.

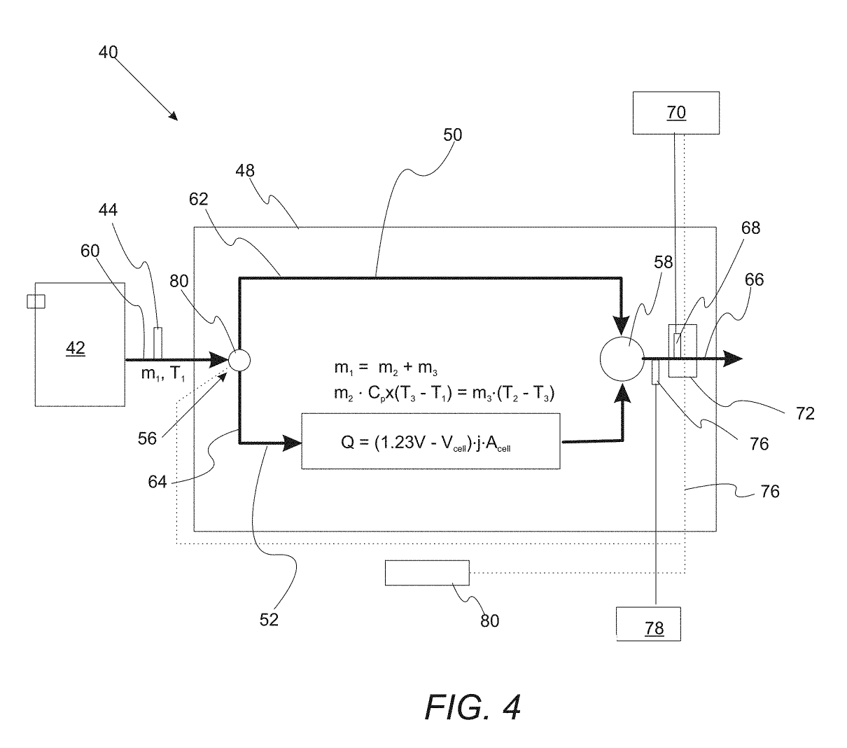

With reference to FIG. 4, a schematic cross section of a fuel cell temperature-measuring system is provided. Fuel cell temperature-measuring system 40 includes coolant source 42 that provides a liquid coolant at a total coolant flow rate and an initial coolant temperature. Temperature sensor 44 measures the initial coolant temperature. Flow field plate 48 defines coolant flow channels 50, 52 through which the liquid coolant flows as set forth above with respect to the description of FIGS. 1 and 2. Peripheral flow channels 50 collectively represents the cooling channels that flow around the periphery of flow field 48. Active area flow channels 52 collectively represent the cooling channels that flow over the active areas of the fuel cell where the electrochemical electricity generation is occurring. Peripheral flow channels 50 diverge from a common input 56 and converge to a common output 58. Characteristically, flow field plate 48 is adapted to be positioned in a fuel cell stack between individual fuel cells as depicted in FIGS. 1 and 2. The initial coolant stream 58 has a total coolant flow m₁ and temperature T₁ and is provided to common input 56 where it divides into a bypass flow stream 62 that flows through the peripheral flow channels 50 with a bypass coolant flow rate m₂ and a bypass coolant temperature T₂ and an active area flow stream 64 that flows through the active area flow channels 52 with an active area flow rate m₃ and an active area temperature T₃. The bypass flow combines with the active area flow to emerge from the common output 58 as a recombined coolant stream 66 having a combined flow rate m₁ and an output coolant temperature T₃. It should be noted that the flows of the initial coolant stream 60 and the recombined coolant stream 66 can be taken as equal due to flow continuity. Temperature sensor 68 measures the output coolant temperature T₃ from the common output 58. Temperature estimator 70 estimates an active area coolant temperature from the output coolant temperature T₃ as set forth below in more detail. Temperature estimator 70 can be a computer processor controller or a proportional-integral-derivative controller (PID). In a refinement, temperature sensor 68 is part of a temperature controller 72 that is capable of controlling the output coolant temperature T₃ if this value is below a predetermined set point Tₛₚ as described below in more detail. The temperature of the coolant (e.g., the coolant temperature at the active area) is controlled/adjusted via feedback loop 76 which is used to control a temperature adjusting effector such as coolant mixing valve 78 and/or radiator fan 80 to adjust the temperature of the liquid coolant.

In a variation, fuel cell temperature-measuring system 40 also includes pressure sensor 76 for measuring the pressure of the liquid coolant at or after the common output 58. Pressure estimator 78 is used to estimate the pressure difference between the input liquid coolant and the output liquid coolant is accordance to the method set forth below. Pressure estimator 78 can be a computer processor controller or a PD.

Typically, temperature estimator 70 determines the active area coolant temperature by solving equations 1 to 4. The active area coolant temperature is the temperature of the coolant when adjacent to the active areas of a fuel cell, i.e., the fuel cell catalyst layers where the electrochemical reactions are occurring. In this regards, Assume coolant inlet flow rate and temperature are m₁ and T₁, stack coolant bypass flow rate and temperature are m₂ and T₁, non-bypass loop flow rate and temperature are m₃ and T₂, with the energy balance model. Application of an energy balance model leads to the equations that can be used to determine the active area temperature:

m₁=m₂+m₃ Eq. (1)

m₂×Cₚ×(T₃−T₁)=m₃×Cₚ×(T₂−T₃) Eq. (2)

The coolant bypass ratio is dependent on the total coolant flow rate (m₁) and coolant inlet temperature (T₁):

$${Cool}_{Bypass} = \frac{{m}_{2}}{{m}_{1}} = f ( {m}_{1} , {T}_{1} ) \qquad Eq . ( 3 )$$

Combining Equations (1), (2) and (3) the active area temperature is:

$${T}_{Active Area} = {T}_{3} + ( \frac{1}{1 - \frac{{m}_{2}}{{m}_{1}}} - 1 ) \times ( {T}_{3} - {T}_{1} ) \qquad Eq . ( 4 )$$

where T₃ is the output temperature and

$$\frac{{m}_{2}}{{m}_{1}}$$

read from a look-up tame eased on coolant overall flow rate and coolant inlet temperature. Where Q is the thermal waste heat of the fuel cell reaction (kW), 1.23V is the thermodynamic equilibrium potential of the cell, Vcell is the operating cell voltage, j is the operating current density (A/cm²), and Acell is the electrochemically active area of the cell (cm²).

Some current fuel cell temperature control algorithm use a PID controller based on the stack coolant outlet temperature feedback (e.g., temperature controller in FIG. 4). However, as CFD data in FIG. 3 shows, the stack coolant bypass can cause local stack active area temperature of up to 10° C. higher than the temperature sensor measurement. In low or mid-power conditions this deviation would not cause active area overheat or dry out. However, in high power range or thermal excursion condition, controlling based on output flow temperature feedback can cause a severe overheat or dry out in stack active area thereby reducing the fuel cell stack life. The system of FIG. 4 provides a strategy for dealing with this phenomenon while having the flexibility in switching between using the output coolant temperature T₃ and the estimated active area temperature as the feedback signal. In low or mid power range when T₃ is less than predetermined set point temperature Tₛₚ which is a calibratable threshold, temperature control is based on T₃ as usual. In the high power or excursion case when T₃ is larger than predetermined set point temperature Tₛₚ, temperature control switches to active area temperature determined by the system of FIG. 4. In a refinement, the predetermined set point temperature is from 80° C. to 100° C. (e.g., about 90° C.). By making this change, the coolant pump and coolant mixing valve are be controlling to a higher temperature that more accurately represents what the stack is experiencing, which also benefits stack durability. This control is active at the same time the active area outlet temperature is used in the relative humidity (RH) estimation. Similar to temperature control, thermal excursion power limitation is another instance where using active area temperature will be beneficial. This is where the largest difference between stack coolant outlet temperature and active area temperature is seen. By using the active area temperature, power limitation begins sooner than it would by using stack coolant outlet temperature. The power limitation lowers high risk events such as shorting, but also reduces the damage to the stack, prolonging stack durability.

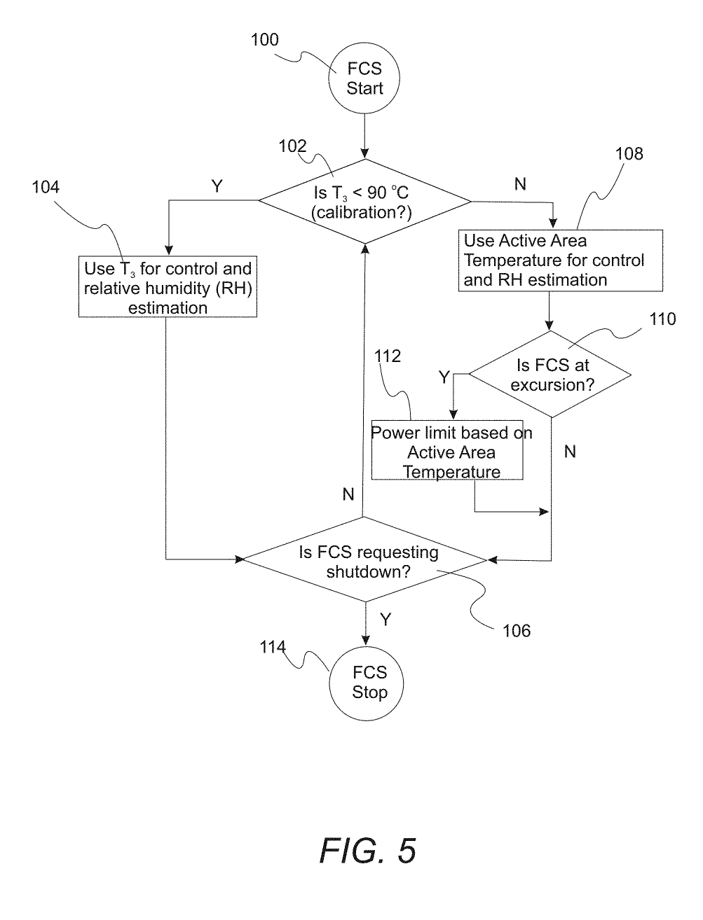

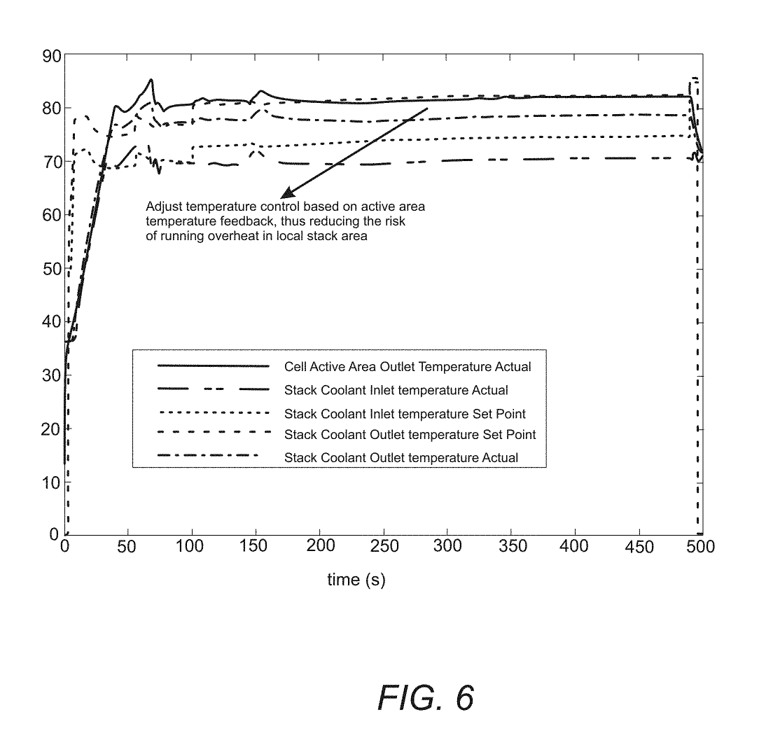

With reference to FIG. 5, a flow chart illustrating a method for controlling the fuel cell stack active area temperature is provided. In box 100, the method is initiated. A determination as to whether or not the output temperature T₃ is less than the set point temperature is illustrated by box 102. If the output temperature T₃ is lower than the set point temperature Tₛₚ, the temperature controller 72 is used to control temperature as usual (box 104). The system then proceeds to a determination if a fuel cell system shutdown is being requested (box 106). If the output temperature T₃ is equal to or higher than the set point temperature T_{T}, the active area estimation method set forth above is used to control temperature as usual (box 108). When the active area estimation method is used, a determination is made if there is a thermal excursion (box 110). Determination of excursion is established from other inputs from the vehicle including fuel cell output power, ambient temperature, vehicle speed, and fuel cell coolant temperature at the stack outlet. If there is a thermal excursion, the power is limited based on the active area temperature (box 112). The system then proceeds to a determination if a fuel cell system shutdown is being requested (box 106). If there is no thermal excursion, the system proceeds directly to a determination if a fuel cell system shutdown is being requested (box 106). In each case, if a fuel cell system shutdown is not being request, the system proceeds to determining as to whether or not the liquid output temperature T₃ is less than the set point temperature (box 102). If shutdown is requested, the fuel cell system shuts down (box 114). FIG. 6 provides Temperature Control Simulation Data based on Active Area Temperature. FIG. 6 shows the necessity of controlling to active area temperature due to the offset between active area temperature (dark blue) and sensed stack outlet temperature after the flow has mixed with the cooler bypass flow (purple), with a deviation of 5C. This can lead to a significant difference in humidity in the stack, which can negatively impact the useful life of the fuel cell stack.

In a variation, the fuel cell stack temperature-measuring system also allows for coolant pressure drop estimation and coolant leak diagnostic based on active area temperature and stack coolant bypass estimation. In this regard, total coolant flow rate is dependent on pump characteristics and is a function of pump speed based on pump curve. With estimated stack coolant bypass, the coolant flow rate going through the stack is:

dV_{Stack}^{CoolByp}=r_{bypass}×dVₜₒₜₐₗ=r_{bypass}×f(\dot{n}ₚᵤₘₚ) Eq. (5)

Stack coolant pressure drop is equal to coolant pressure drop through the bypass loop and can be obtained from the following equation

Δp_{Stack}^{Cool}=k_{StackByp}^{Lam}*μ(T_{StckCoolIn}^{FB})*dV_{Stack}^{CoolByp}+k_{StackByp}^{Turb}*ρ(T_{StckCoolIn}^{FB})*(dV_{Stack}^{CoolByp})² Eq. (6)

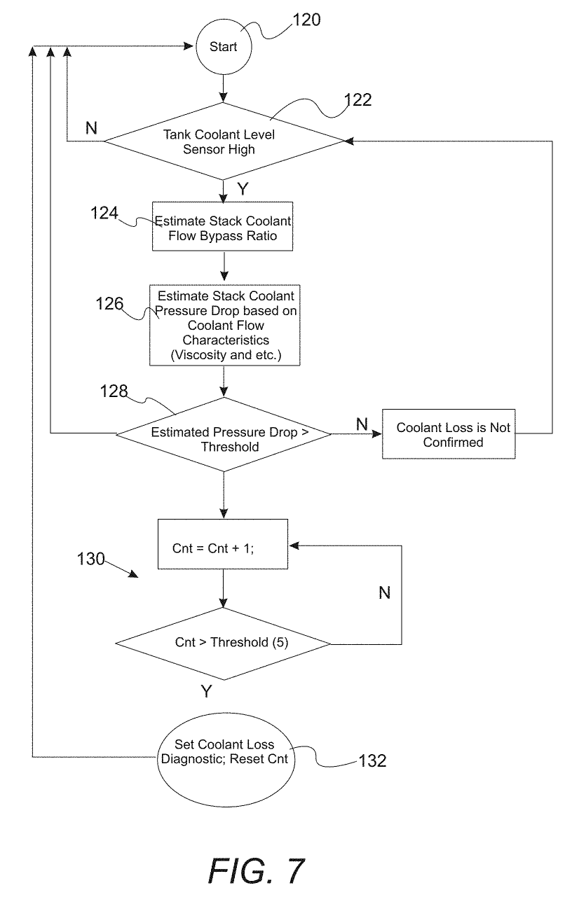

dV_{Stack}^{CoolByp} is the stack coolant bypass flow rate, r_{bypass} is the bypass ratio, dVₜₒₜₐₗ is the total coolant flow into the fuel cell stack, \dot{n}ₚᵤₘₚ is the coolant pump rotational speed (therefore, f(\dot{n}ₚᵤₘₚ) is a function), Δp_{Stack}^{Cool} is the stack pressure drop in the coolant loop, k_{StackByp}^{Lam} is the laminar flow coefficient of the stack bypass flow, μ(T_{StckCoolIn}^{FB}) is the dynamic viscosity of the coolant as a function of stack coolant inlet temperature feedback, k_{StackByp}^{Turb} is the turbulent flow coefficient of the stack bypass flow, and ρ(T_{StckCoolIn}^{FB}) is the density of the coolant as a function of stack coolant inlet temperature. Equation (6) gives the formula to estimate the pressure drop in the stack coolant loop and can be used to compare with nominal stack coolant pressure drop threshold. If a larger-then-threshold pressure drop is estimated, it indicates a stack coolant leak. FIG. 7 provides a flowchart showing the implementation of a pressure estimation method. In box 120, the system starts the coolant pressure drop estimation. The system determines if a coolant tank level sensor is reading that the coolant level is high (box 122). If the level is not high, the system returns to start. If the level is low, the system estimates the stack coolant bypass ratio (box 124) and the stack coolant pressure drop based on coolant flow characteristics using equations 5 and 6 (box 126). A determination is made as to whether or not the estimated pressure drop is higher than a threshold pressure value (box 128). If the pressure drop is not higher than the predetermined threshold pressure value, the system returns to start. If the pressure drop is higher than the threshold pressure value, the system enters an optional delay loop 130 where a counter is incremented until it surpasses a predetermined counter threshold value. The system then proceeds run a coolant loss diagnostic and reset the counter (box 132). If the coolant loss is not confirmed, the system proceeds to determining if the coolant level is high (box 122). The entire control loop starts again with reading the coolant level sensor.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fuel cell temperature-measuring system comprising:
a coolant source that provides liquid coolant at a total coolant flow rate and an initial coolant temperature;
a flow field plate defining coolant flow channels through which the liquid coolant flows, the coolant flow channels including peripheral flow channels and active area flow channels, the peripheral flow channels and the active area flow channels diverging from a common input and converging to a common output, the flow field plate adapted to be positioned in a fuel cell stack between individual fuel cells wherein an input liquid coolant with a total coolant flow rate provided to the common input divides into a bypass flow that flows through the peripheral flow channels with a bypass coolant flow rate and a bypass coolant temperature and an active area flow that flows through the active area flow channels with an active area flow rate and an active area temperature, the bypass flow combining with the active area flow to emerge from the common output as an output liquid coolant with an output coolant temperature;
a temperature sensor that measures the output coolant temperature from the common output; and
a temperature estimator that estimates an active area coolant temperature from the output coolant temperature.

2. The fuel cell temperature-measuring system of claim 1 wherein the temperature estimator determines the active area coolant temperature by solving equations 1 to 4:
$$\begin{matrix}{m}_{1} = {m}_{2} + {m}_{3} & ( 1 ) \\ {m}_{2} \times {C}_{p} \times ( {T}_{3} - {T}_{1} ) = {m}_{3} \times {C}_{p} \times ( {T}_{2} - {T}_{3} ) & ( 2 ) \\ {Cool}_{Bypass} = \frac{{m}_{2}}{{m}_{1}} = f ( {m}_{1} , {T}_{1} ) & ( 3 ) \\ {T}_{Active Area} = {T}_{3} + ( \frac{1}{1 - \frac{{m}_{2}}{{m}_{1}}} - 1 ) \times ( {T}_{3} - {T}_{1} ) & ( 4 )\end{matrix}$$
where:
m₁ is total coolant flow rate;
m₂ is bypass coolant flow rate;
m₃ is active area coolant flow rate;
Cₚ is the heat capacity of the liquid coolant;
T₁ is the bypass coolant temperature;
T₂ is the active area temperature;
T₃ is the output coolant temperature;
T_{Active Area} is the active area temperature; and
Cool_{Bypass} is a ratio to the bypass coolant flow rate to the total coolant flow rate that is predetermined from a coolant overall flow rate and coolant inlet temperature.

3. The fuel cell temperature-measuring system of claim 2 further comprising a temperature controller that controls liquid coolant temperature if the output coolant temperature is less than a predetermined set point temperature.

4. The fuel cell temperature-measuring system of claim 3 wherein the predetermined set point temperature is from 80° C. to 100° C.

5. The fuel cell temperature-measuring system of claim 3 wherein the temperature estimator is used to estimate the active area coolant temperature from the output coolant temperature if the output coolant temperature is equal to or greater than the predetermined set point temperature.

6. The fuel cell temperature-measuring system of claim 2 further comprising a temperature adjusting effector for controlling liquid coolant temperature, the temperature adjusting effector in electrically communication with a temperature controller that

[symbol]

7. The fuel cell temperature-measuring system of claim 2 further a coolant level sensor determines if a coolant level is higher than a predetermined cooling level.

8. The fuel cell temperature-measuring system of claim 7 further comprising a pressure sensor that measures a pressure of the liquid coolant.

9. The fuel cell temperature-measuring system of claim 8 further comprising a pressure difference estimator that estimates a pressure difference between the input liquid coolant and the output liquid coolant.

10. The fuel cell temperature-measuring system of claim 1 adapted to measure liquid coolant temperature in a fuel cell that is incorporated into a fuel cell stack.

11. A method for measuring temperature of a fuel cell, the method comprising:
providing liquid coolant at a total coolant flow rate and an initial coolant temperature to a fuel cell flow field plate, the fuel cell flow field plate defining coolant flow channels through which the liquid coolant flows, the coolant flow channels including peripheral flow channels and active area flow channels, the peripheral flow channels and active area flow channels diverging from a common input and converging to a common output, the fuel cell flow field plate adapted to be positioned in a fuel cell stack between individual fuel cells wherein an input liquid coolant with a total coolant flow rate provided to the common input divides into a bypass flow that flows through the peripheral flow channels with a bypass coolant flow rate and a bypass coolant temperature and an active area flow that flows through the active area flow channels with an active area flow rate and an active area temperature, the bypass flow combining with the active area flow to emerge from the common output as an output liquid coolant with an output coolant temperature;
measuring the output coolant temperature from the common output; and
estimating an active area coolant temperature from the output coolant temperature.

12. The method of claim 11 wherein the active area coolant temperature is estimated by solving equations 1 to 4:
$$\begin{matrix}{m}_{1} = {m}_{2} + {m}_{3} & ( 1 ) \\ {m}_{2} \times {C}_{p} \times ( {T}_{3} - {T}_{1} ) = {m}_{3} \times {C}_{p} \times ( {T}_{2} - {T}_{3} ) & ( 2 ) \\ {Cool}_{Bypass} = \frac{{m}_{2}}{{m}_{1}} = f ( {m}_{1} , {T}_{1} ) & ( 3 ) \\ {T}_{Active Area} = {T}_{3} + ( \frac{1}{1 - \frac{{m}_{2}}{{m}_{1}}} - 1 ) \times ( {T}_{3} - {T}_{1} ) & ( 4 )\end{matrix}$$
where:
m₁ is total coolant flow rate;
m₂ is bypass coolant flow rate;
m₃ is active area coolant flow rate;
Cₚ is the heat capacity of the liquid coolant;
T₁ is the bypass coolant temperature;
T₂ is the active area temperature;
T₃ is the output coolant temperature;
T_{Active Area} is the active area temperature; and
Cool_{Bypass} is s ratio to the bypass coolant flow rate to the total coolant flow rate that is predetermined from a coolant overall flow rate and coolant inlet temperature.

13. The method of claim 12 whether a temperature controller controls liquid coolant temperature if the output coolant temperature is less than a predetermined set point temperature.

14. The method of claim 13 wherein the predetermined set point temperature is from 80° C. to 100° C.

15. The method of claim 13 wherein a temperature estimator is used to estimate the active area coolant temperature from the output coolant temperature if the output coolant temperature is equal to or greater than the predetermined set point temperature.

16. The method of claim 15 further comprising controlling liquid coolant temperature with a temperature adjusting effector.

17. The method of claim 12 further comprising determining if coolant level is higher than a predetermined cooling level.

18. The method of claim 17 further comprising measuring an output coolant pressure of the output liquid coolant.

19. The method of claim 18 further comprising estimating a coolant pressure difference from equations 5 and 6:
dV_{Stack}^{CoolByp}=r_{bypass}×dVₜₒₜₐₗ=r_{bypass}×f(\dot{n}ₚᵤₘₚ) Eq. (5)
Δp_{Stack}^{Cool}=k_{StackByp}^{Lam}*μ(T_{StckCoolIn}^{FB})*dV_{Stack}^{CoolByp}+k_{StackByp}^{Turb}*ρ(T_{StckCoolIn}^{FB})*(dV_{Stack}^{CoolByp})² Eq. (6)
wherein:
dV_{Stack}^{CoolByp} is the stack coolant bypass flow rate, r_{bypass} is the bypass ratio, dVₜₒₜₐₗ is the total coolant flow into the fuel cell stack, \dot{n}ₚᵤₘₚ is the coolant pump rotational speed, Δp_{Stack}^{Cool} is the stack pressure drop in the coolant loop, k_{StackByp}^{Lam} is the laminar flow coefficient of the stack bypass flow, μ(T_{StckCoolIn}^{FB}) is the dynamic viscosity of the coolant as a function of stack coolant inlet temperature feedback, k_{StackByp}^{Turb} is the turbulent flow coefficient of the stack bypass flow, and ρ(T_{StckCoolIn}^{FB}) is the density of the coolant as a function of stack coolant inlet temperature.

20. The method of claim 19 wherein a pressure diagnostic is executed if the estimated pressure difference is greater than a predetermined pressure threshold.
